(19) United States
(12) Patent Application Publication
(10) Pub. No.: US 2010/0196072 A1
(43) Pub. Date: Aug. 5, 2010

(54) MODULAR COLOR XEROGRAPHIC PRINTING ARCHITECTURE

(75) Inventors: Stephen P. Hoover, Penfield, NY (US); Daniel W. Costanza, Webster, NY (US); Barry P. Mandel, Fairport, NY (US)

Correspondence Address: Hoffmann & Baron, LLP, 6900 Jericho Turnpike, Syosset, NY, 11791, US

(73) Assignee: XEROX CORPORATION, Norwalk, CT (US)

(21) Appl. No.: 12/364,675

(22) Filed: Feb. 3, 2009

(51) Int. Cl. G03G 15/00

(52) U.S. Cl. 399/395

(57) ABSTRACT

A printing apparatus comprises a plurality of substantially identical modules forming a common sheet path. Each module includes an image receptor, a supply of marking material of a predetermined type, and a marking engine for creating an image of marking material on the sheet. Within each module a transport receives a sheet, moves the sheet to receive the image from the marking engine, and makes the sheet available for printing by a subsequent module in the sheet path. A sheet sensing system within each module detects a position of the sheet and uses that information to adjust the position of the image to be transferred to the sheet.

### INCORPORATION BY REFERENCE

The following US patent application is incorporated in its entirety for the teachings therein: U.S. Ser. No. 12/262,803, filed Oct. 31, 2008, entitled METHOD OF AND SYSTEM FOR MODULE TO MODULE SKEW ALIGNMENT, assigned to the assignee hereof (Attorney File No. 20080589).

### TECHNICAL FIELD

The present disclosure relates to a modular architecture for electrostatographic or xerographic printing systems.

### BACKGROUND

Printer architectures for color xerographic printing are well known. In general, there are provided a number of development units, each development unit contributing to the printing process a toner for a component color of the printed image. In the case of a full-color printing apparatus, there are typically four development units, cyan, magenta, yellow, and black (CMYK). In a “highlight color” printing apparatus, where it desired to print black plus one other predetermined color, a typical arrangement is to have a black development unit and one or more development units, one for each of a selectable set of highlight colors, only one of which would be used at a time. Other types of architecture include “hexachrome,” where there are two additional color development units beyond CMYK, thus providing an extended color gamut for the printer; and arrangements that include a development unit for applying clear toner, or one applying a toner with special properties such as MICR (magnetic ink character recognition) toner.

Examples of typical basic color xerographic architectures are shown in U.S. Pat. Nos. 6,628,909; 7,177,585; and 6,871,037. Variously, the development units could be arranged around a single photoreceptor belt; each development unit could be associated with a single drum photoreceptor, and the drum photoreceptors arranged around a common “intermediate belt” that accumulates the primary-color toner images for transfer to a print sheet; or the drum photoreceptors could each directly transfer their primary-color images to a sheet moving past each photoreceptor. U.S. Pat. No. 6,718,879 and U.S. Patent Application Publication 20010043823 show examples of control systems useful for accurate placement of images in a large color printer.

The present disclosure relates to a modular architecture for xerographic printing, in which separate modules, each providing one type of toner, can be selectably combined and operated for various purposes.

### SUMMARY

According to one aspect, there is provided a printing apparatus, comprising a plurality of substantially identical modules forming a common sheet path. Each module includes an image receptor, a supply of marking material of a predetermined type, and means for creating an image of marking material on the image receptor. Each module further includes a transport for receiving a sheet, moving the sheet to receive the image from the image receptor, and making the sheet available for printing by a subsequent module in the sheet path. A sheet sensing system detects the position of a sheet received by the transport. A correction module altering the image created by the marking engine based on a signal from the sheet sensing system.

According to another aspect, there is provided a module for use in a printing apparatus. The module includes an image receptor, a supply of marking material of a predetermined type, and means for creating an image of marking material on the image receptor. Each module further includes a transport for receiving a sheet, moving the sheet to receive the image from the image receptor, and making the sheet available for printing by a subsequent module in the sheet path. A sheet sensing system detects the position of a sheet received by the transport. A correction module altering the image created by the marking engine based on a signal from the sheet sensing system.

### BRIEF DESCRIPTION OF THE DRAWINGS

FIG. 1 shows five possible configurations of a xerographic printer design.

FIG. 2 is an elevational view of a module in isolation.

FIG. 3 is a plan view of an exemplary sheet sensing system.

FIG. 4 is a simplified, perspective, view showing, in isolation, a set of photoreceptors, and some samples of partial images, illustrating the operation of a full-color printer.

FIG. 5 shows a possible configuration of a printer with digital and non-digital modules.

### DETAILED DESCRIPTION

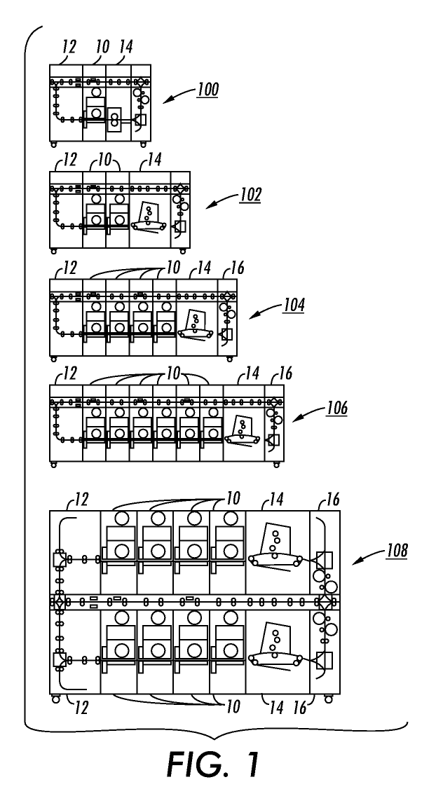

FIG. 1 shows five possible configurations, labeled respectively 100, 102, 104, 106, and 108, of a xerographic printer design. Each configuration includes one or more modules, each indicated as 10 in the various configurations. Configuration 100 includes one module 10; configuration 102 includes two modules 10; configuration 104 includes four modules 10; and configuration 106 includes six modules 10. In any configuration, each module 10 includes structure forming a portion of a sheet path and printing hardware to place printing material of a predetermined type (“type” referring to color or some other attribute, such as MICR properties) on a print sheet passing through the sheet path: in any other significant aspects, all modules 10 are substantially identical in design. In this way, by providing a given number of modules along a common sheet path and providing different types of printing material in each module, an overall printing apparatus can effectively be custom made.

For instance, if a simple monochrome printer such as 100 is desired, a single module 10, supplied with black toner, is combined with an input module 12 and a fusing module 14, as well as a sheet exit module 16 as needed. Sheet-feeding and finishing modules, such as for stapling or booklet-making, not shown, could be provided as well. As can be seen, the combination of modules “adds up” to a monochrome printing apparatus 100. If a “highlight color” printer is desired, two modules 10, one with black toner and one with the highlight color toner, are provided, forming printer 102. If a “full color” printer is desired, four modules 10, one with black toner and the others with cyan, magenta, and yellow toners respectively, are provided, forming printer 104. Printer 106, having six modules 10, could provide black, cyan, magenta, and yellow toners respectively, along with two additional types of toner for a hexachrome or other special-purpose printer 106. Printer 108 uses a “stack” of two sets of modules 10, along with input modules, fuser modules 14, and sheet exit modules 16, for a high-productivity color printer.

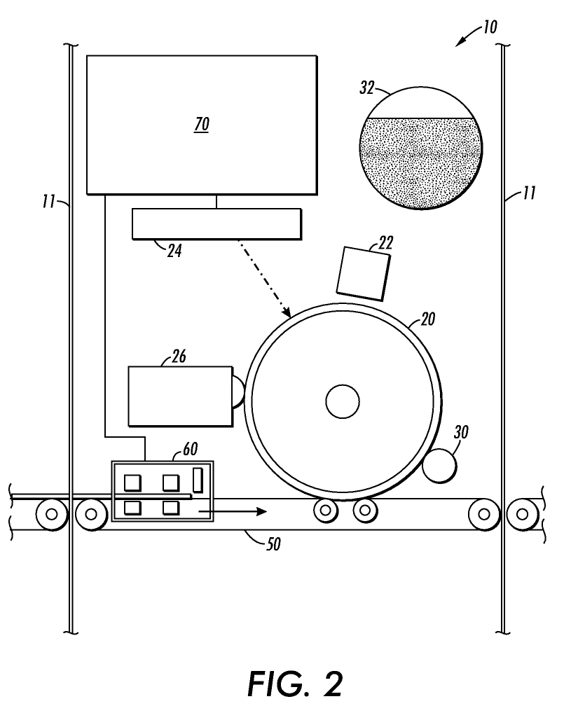

FIG. 2 is an elevational view of a portion of a module 10 in isolation. Module 10 includes what can be broadly called a “marking engine.” In the present embodiment, the marking engine is of an electrostatographic or xerographic type, and includes an image receptor in the form of drum photoreceptor 20, around which are disposed the familiar elements of xerographic printing for a single color or type of marking material, such as charge device 22, exposure device 24, development unit 26, transfer zone formed by transport 50 (to be described in detail below), and cleaning device 30. Feeding into development unit 26 is a source 32 of marking material. The marking material may include toner, developer particles, etc., of a given type to place an image on the photoreceptor 20 according to the operation of exposure device 24. It should be noted that in this embodiment, the module 10 includes no fuser within its sheet path. Broadly speaking, the xerographic elements form a means for creating an image of marking material on the photoreceptor 20, but other technologies, such as various forms of ink-jet, may be used in alternative embodiments of the marking engine within a module 10.

Further within a module 10 is a structure that can be generally called a “transport” 50 for carrying a sheet through the portion of the sheet path corresponding to the module 10. The overall function of transport 50 includes receiving a sheet, moving the sheet through the sheet path to receive a toner image from the photoreceptor 20, and making the sheet available for printing by a subsequent module 10 in the sheet path. In the embodiment, the transport 50 also has the function of bringing a sheet in contact with the photoreceptor 20. Further as shown, the transport 50 in this embodiment includes a single belt, extending the length of the portion of the sheet path corresponding to the module 10. All of the printer hardware for a module 10 is supported by a frame 11, having the function of supporting at least the photoreceptor 10 and the transport 50, the frame 11 being configured for attachment of a prior and a subsequent module to form the common sheet path.

As shown in the FIG. 2 embodiment, there is further provided a sheet sensing system 60, disposed to detect the position of a sheet being received in module 10 and travelling on transport 50. The sheet sensing system 60, a detailed version of one embodiment of which will be described below, should have the capability, in terms of response time and image resolution, to detect anomalies in position of a sheet received on transport 50, and output what can be called an “error signal” related to any anomaly. This error signal in turn can be used to influence exposure device 24: as will be noted, sheet sensing system 60 will be looking at an edge or a particular small area on a sheet on transport 50 slightly before the exposure device 24 is creating a corresponding portion of an electrostatic latent image on the photoreceptor 20, in such a way that an anomaly detected at a given moment by sheet sensing system 60 can be detected and compensated for shortly thereafter by exposure device 24. Thus, after the latent image is developed at development unit 26 and transferred to the print sheet at the transfer zone, the pre-existing printed image on the sheet and the corrected, newly-transferred image will “match,” particularly in a color-separation registration sense. (Equivalent functionality will be apparent in a module where the print engine uses ink-jet technology.)

In the illustrated embodiment, the various error signals output by sheet sensing system 60 within each module 10 are collected by what is here called a “correction module,” indicated as 70. The overall function of correction module 70, which incorporates both hardware and software (and can be considered as part of a larger image-processing system which accepts partial image data to be printed by a printing module 10), is to take error signals relating to positional or other abnormalities associated with an incoming print sheet, and cause these anomalies to influence the print engine, ultimately the behavior of a modulating laser or ionographic head in an electrostatographic marking device, or an ink-jet printhead in an ink-jet printing device.

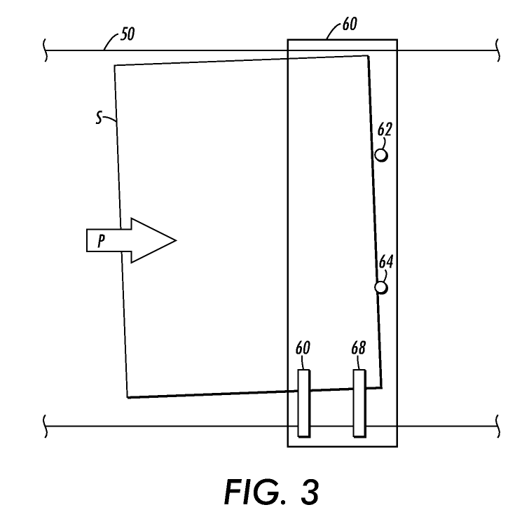

FIG. 3 is a plan view of an exemplary sheet sensing system 60. This system includes two point sensors 62 and 64 that can be used to detect the skew of the lead edge of the sheet S as well as to detect the process direction position P of the sheet as the sheet S moves on transport 50. The system further includes two array sensors 66 and 68 positioned to detect a lateral edge of the sheet S, as shown. These two array sensors can be used to detect the skew of the edge of the sheet and to detect the position of the sheet in the cross process direction. Thus the position of the sheet can be detected in all three degrees of freedom; skew, process and cross process position; in this way the associated correction module 70 for the particular module 10 can effectively move the image about to be printed in response to these positional anomalies. Further, in some embodiments, the sheet sensing system 60 can detect the size of an incoming sheet (or, with suitable sensors, an image on the sheet), and the correction module 70 can take that information to influence the marking engine to change a size and/or aspect ratio of the image to be printed by the module 10; this ability to make magnification corrections is useful in situations where it is possible that a single print sheet may change in size (such as caused by changes in temperature or moisture content) in the course of the printing process.

It should be appreciated that any sheet sensing system 60 that can detect the position of incoming media could be used in the present invention and that the present invention is in no way limited to the use of the sensing system shown in this example. A related system is described in U.S. Ser. No. 12/262,803, filed Oct. 31, 2008, entitled METHOD OF AND SYSTEM FOR MODULE TO MODULE SKEW ALIGNMENT, cited above.

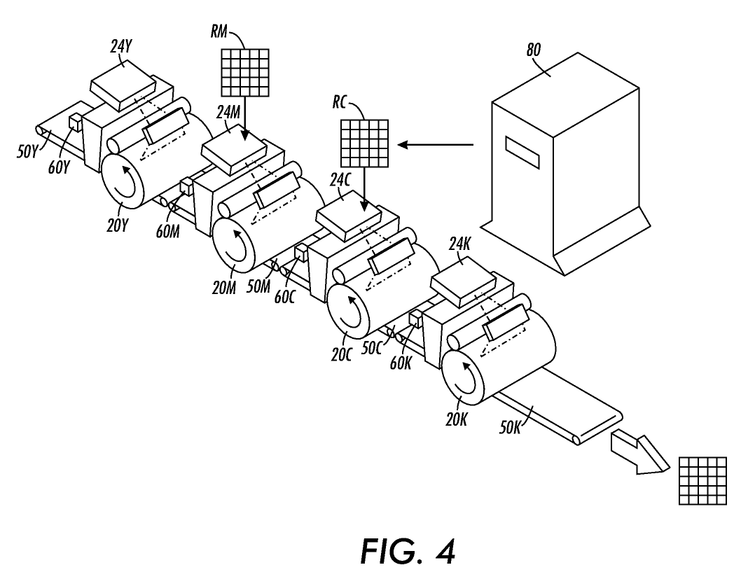

FIG. 4 is a simplified, perspective, view showing, in isolation, a set of photoreceptors 20Y, 20M, 20C, and 20K, and some samples of partial images (such as color separations for a full-color image), illustrating the operation of a full-color printer. Each of the four photoreceptors, with its associated exposure device 24Y, 24M, 24C, 24K, is labeled for the type of color separation (yellow, magenta, cyan, black) it places on a sheet passing through the common sheet path. Each photoreceptor is associated with a transport 50Y, 50M, 50C, 50K, which are arranged in series, as shown to form a single sheet path, Immediately upstream of each photoreceptor along the sheet path is a sheet sensing system 60Y, 60M, 60C, 60K, performing the above-described function for its associated exposure device. The coordination of the exposure devices and sensors for an entire printing system is provided by a central processor or computer, shown as 80, through which the image data desired to be printed is channeled. The central processor 80, in an embodiment, would also have the function of separating incoming image data to be printed, typically in a high-level language such as pdf, into suitable color separation data directed to each module 10 for creating a full-color image along the entire sheet path.

Further shown in FIG. 4 are sample two-dimensional printed rasters for magenta and cyan, indicated as RM and RC respectively. These rasters can be considered a kind of test pattern as would be printed during a set-up of the printing apparatus, although any kind of test pattern (or even customer images) can be used for purposes of a control system. As shown for demonstration purposes, each raster includes positional anomalies of the printed image on the sheet, an anomaly which largely relates to inaccuracies in sheet feeding and image transfer. Absent any correction, as shown, raster RM could be skewed or otherwise mispositioned in one way and raster RC is skewed or otherwise mispositioned in another. The function of the control system is to determine the skew or other anomaly from an incoming print sheet detected by a sheet sensing system 60, and influence the creation of one or both rasters to yield a largely undistorted, suitably superimposed set of images, such as would be required for printing a satisfactory full-color image, such as shown as RX.

In possible implementations, the central processor 80, governing and coordinating a plurality of printing modules 10, can interact with the correction modules 70 within each print module 10. In other words, correction of positional or magnification anomalies among a series of modules along a print path can be divided between the correction module 70 associated with each print module 10 and the central processor 80 controlling the whole print path. In one implementation, anomalies within a predetermined spatial range (smaller than, for example, 0.5 mm) can be corrected internally within each print module 10, while larger or cumulative spatial anomalies are effectively referred to central processor 80, such as for more systemic correction and/or notifying the human user. An example of systemic correction, for any purpose, would include having a marking device in an upstream module 10 along the sheet path move the images it produces in response to a positional anomaly detected in a downstream module 10, as opposed or in addition to a single module 10 making the correction in response to detecting the anomaly on a incoming sheet and performing the correction entirely internally. Another arrangement could provide for the central processor 80 detecting recurrent patterns of positional errors as individual modules are used, and determining a course of action.

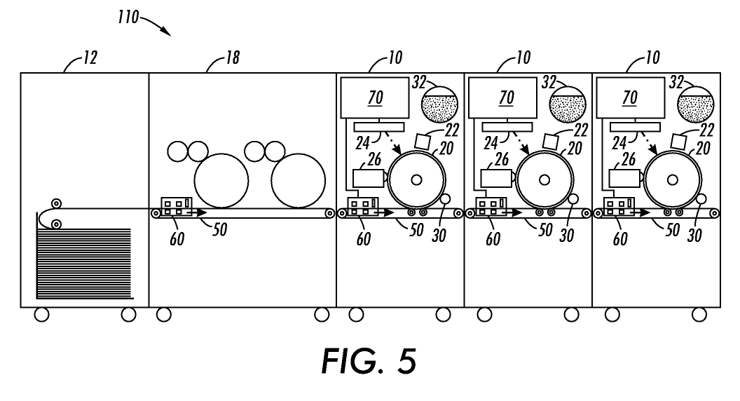

Although the illustrated embodiment describes what can be called a “digital” printing system, in that the marking engine, whether electrostatographic, ink-jet, or some other printing technology, ultimately relies on input image data in digital form, certain of the print modules in a larger system may use analog or fixed-image systems, such as offset or flexographic printing. For instance, if it is desired to print a magazine in which only portions of the image data, such as a mailing address, are variable from print to print, and the rest comprising the same partial image for every print, only a subset of all of the modules forming the sheet path need be responsive to digital image data. The non-digital modules could use another technology, such as offset or flexographic. FIG. 5 shows a printing system 110, similar those shown in FIG. 1 above, but with the addition of what can be called an analog or non-digital (such as offset or flexographic, as those terms are broadly understood in the art of printing) module 18, which work in series with a printing module 10 and other types of module as described above. Even modules using non-digital technology could be designed to be somewhat responsive to image correction based on anomalies detected by a sheet sensing system, e.g., a module using a flexographic system could be designed to adjust placement of the image in a process direction (by adjusting the rotational position of an image roll between prints) or cross-process direction (by moving the roll longitudinally) substantially in real time as print sheets are accepted by such a module. Even a non-digital module such as 18 can include a sheet sensing system such as shown as 60 above, for detecting the position of a sheet received by the transport thereof, and can relay any error signal therefrom to a central processor such as shown as 80 above, for helping control of an entire print apparatus.

The claims, as originally presented and as they may be amended, encompass variations, alternatives, modifications, improvements, equivalents, and substantial equivalents of the embodiments and teachings disclosed herein, including other marking technologies such ink jet printing and those that are presently unforeseen or unappreciated, and that, for example, may arise from applicants/patentees and others.

What is claimed is:

1. A printing apparatus, comprising a plurality of substantially identical modules forming a common sheet path, each module including
a supply of marking material of a predetermined type;
a marking engine for creating an image of marking material on a sheet;
a transport for receiving a sheet, moving the sheet to receive the image from the marking engine, and making the sheet available for printing by a subsequent module in the sheet path;
a sheet sensing system for detecting the position of a sheet received by the transport; and
a correction module for altering the image created by the marking engine based on a signal from the sheet sensing system.

2. The module of claim 1, the marking engine including an electrostatographic image receptor.

3. The module of claim 2, the module not including a fuser.

4. The module of claim 2, the transport bringing a print sheet in contact with the image receptor to receive marking material therefrom.

5. The module of claim 1, the sheet sensing system including at least one of a point sensor and an array sensor for detecting the lead edge of a sheet traveling on the transport.

6. The module of claim 1, the sheet sensing system including at least two point sensors for detecting a skew of the lead edge of a sheet.

7. The module of claim 1, the sheet sensing system including at least two array sensors for detecting an edge of a sheet.

8. The module of claim 1, the transport including a single belt, extending a length of the portion of the sheet path corresponding to the module.

9. The module of claim 1, further including a frame for supporting the marking engine and the transport, the frame being configured for attachment of a prior and a subsequent module to form the common sheet path.

10. The apparatus of claim 1, wherein each of the plurality of modules is associated with a marking material of a different type.

11. The apparatus of claim 10, wherein the marking materials of a different type are of a different color.

12. The apparatus of claim 1, further comprising a fuser operatively disposed along the sheet path formed by the plurality of modules.

13. The module of claim 1, further comprising a correction module, the sheet sensing system outputting an error signal to the correction module for influencing the marking engine.

14. The module of claim 13, the correction module causing the print engine in a module to shift an image in at least one of a process direction, cross process direction, and skew.

15. The apparatus of claim 1, the correction module causing the print engine in a module to change a magnification of an image created by the module.

16. The apparatus of claim 1, further comprising a central processor operative of a plurality of modules, the central processor separating incoming image data to be printed into color separation data directed to each module.

17. The apparatus of claim 1, further comprising a central processor operative of a plurality of modules, the central processor altering the image created by a marking engine of a downstream module based on a signal from the sheet sensing system of an upstream module along the sheet path.

18. The apparatus of claim 17, wherein, within a module of a plurality of modules, the correction module influences the marking engine to correct an anomaly within a predetermined spatial range.

19. The apparatus of claim 1, further comprising a non-digital module operatively disposed along the sheet path, the non-digital module capable of placing at least a partial image on a sheet.

20. The apparatus of claim 19, the non-digital module including a sheet sensing system for detecting the position of a sheet received by the non-digital module.

21. A module for use in a printing apparatus, comprising
a supply of marking material of a predetermined type;
a marking engine for creating an image of marking material on a sheet;
a transport for receiving a sheet, moving the sheet to receive the image from the marking engine, and making the sheet available for printing by a subsequent module in the sheet path;
a sheet sensing system for detecting the position of a sheet received by the transport; and
a correction module for altering the image created by the marking engine based on a signal from the sheet sensing system.

22. The module of claim 21, the marking engine including an electrostatographic image receptor.

23. The module of claim 22, the module not including a fuser.

24. The module of claim 22, the transport bringing a print sheet in contact with the image receptor to receive marking material therefrom.

25. The module of claim 21, the sheet sensing system including at least one of a point sensor and an array sensor for detecting the lead edge of a sheet traveling on the transport.

26. The module of claim 21, the sheet sensing system including at least two point sensors for detecting a skew of the lead edge of a sheet.

27. The module of claim 21, the sheet sensing system including at least two array sensors for detecting an edge of a sheet.

28. The module of claim 21, the transport including a single belt, extending a length of the portion of the sheet path corresponding to the module.

29. The module of claim 21, further including a frame for supporting the marking engine and the transport, the frame being configured for attachment of a prior and a subsequent module to form the common sheet path.

30. The module of claim 21, further comprising a correction module, the sheet sensing system outputting an error signal to the correction module for influencing the marking engine.

31. The module of claim 30, the correction module causing the print engine in a module to shift an image in at least one of a process direction, cross process direction, and skew.
